(19) United States
(12) Patent Application Publication
(10) Pub. No.: US 2004/0096043 A1
(43) Pub. Date: May 20, 2004

(54) Technique for assisting a user with information services at an information/call center

(76) Inventors: Timothy A. Timmins, Tigard, OR (US); John S. Miller, Canby, OR (US); Christopher A. Huey, Banks, OR (US)

Correspondence Address: Alex L. Yip, Kaye Scholer LLP, 425 Park Avenue, New York, NY, 10022, US

(21) Appl. No.: 10/396,016

(22) Filed: Mar. 25, 2003

Related U.S. Application Data
(60) Provisional application No. 60/427,256, filed on Nov. 18, 2002.
(60) Provisional application No. 60/447,387, filed on Feb. 14, 2003.

(51) Int. Cl. H04M 1/64

(52) U.S. Cl. 379/88.22

(57) ABSTRACT

The present invention is directed to using an information assistance service to send a message to a desired destination, e.g., an e-mail address, or other addresses associated with wireless telephones, pagers, SMSs, PDAs, PIM systems, etc. The message may include multimedia information, e.g., audio, video and/or text information. The information assistance service provider obtains “message overhead” data, as opposed to message content or body, from the caller or from external or internal databases such as the caller's contacts folders (also known as private directories) and user profiles. Such message overhead data may include “envelope” information such as the destination address (e.g., e-mail address) to which the message is to be delivered, destination name, sender's name and return address (e.g., return e-mail address). The data may also include a carbon copy (CC) address(es), a subject line, a signature, and/or notes for attachment to the message body, as well as a message ID for keeping track of the message. The message overhead data are entered automatically into the data fields based on one or more criteria such as the data used in the previous message or the data used most frequently. If the correct data are not available automatically, the operator may type the data in using auto completion. The information assistance service provider transmits the message overhead data to a message server, and connects the caller to the message server to record the message content to complete the message. The message server then integrates the received message overhead data with the recorded message content, and sends the resulting message to the desired destination. Using the message ID, the recipient may send a reply to the sender via the information assistance service provider. The reply, which includes reply overhead data and reply message content, may be in the form of a telephone call or an electronic reply or a combination of the two. The messaging feature of the present invention may be offered to a caller who attempted a call but for some reason the call was incomplete and the caller is returned to the information assistance service provider for more assistance.

### CROSS-REFERENCE TO RELATED APPLICATION

This application claims, under 35 U.S.C. § 119(e), the benefit of U.S. Provisional Patent Application Serial No. 60/427,256, filed Nov. 18, 2002, and U.S. Provisional Patent Application Serial No. 60/447,387, filed Feb. 14, 2003, both of which are incorporated herein by reference.

### BACKGROUND OF THE INVENTION

The invention relates generally to an information assistance system and method. More specifically, the invention relates to a system and method for providing an information assistance service including assisting the entry of data into message data fields so that a user can send the message to a desired party, e.g., via e-mail, and for the party to send a reply.

With the advent of voice messaging, also known as “voicemail,” a person who knows someone else's telephone number is able to make a phone call to that other person and leave him or her a recorded message. With e-mail, a person who knows someone else's e-mail address is able to send an electronic message to that other person.

Recently, a service called Trekmail (see www.trekmail.com) has been developed in which a person who knows someone else's e-mail address is able to send an e-mail, containing a voice message, to that other person using the e-mail system. The caller sets up a profile with Trekmail, including the caller's name, an account number (user ID), a password or personal identification number (PIN), and a “signature” with which to sign the message. In order to use the service, the caller calls a central Trekmail telephone number (or voice message server) and identifies him- or herself using the account number and password. The Trekmail server, using an interactive voice response (IVR) unit, requests from the caller the e-mail address of the person (the recipient) to whom the caller would like to send a message. The caller then records the message using the telephone, the Trekmail server converts the message to a sound file, attaches the sound file to the e-mail message and sends the e-mail message to the recipient. The e-mail message appears in the recipient's e-mailbox with the caller's return e-mail address and the caller's “signature.” In order to hear the message, the recipient opens the e-mail message and the attached sound file.

### SUMMARY OF THE INVENTION

One problem with the Trekmail-type messaging system is the difficulty that the IVR has in recognizing the recipient's e-mail address. E-mail addresses come in many forms, and there are many different ways of verbalizing the addresses. For instance, the typical e-mail address “smith@business.com” includes the recipient's name (“smith”), followed by an “at” sign (“@”), followed by the domain name (“business”), a period, and an extension (“.com”). The sender likely pronounces the address, “smith at business dot com”, and the IVR may be able to recognize it. However, many e-mail addresses differ from this typical address. The recipient's name may include a first initial, e.g., “jsmith,” or a first name, e.g., “jaysmith,” or may include other punctuation to set off the first name from the last name, e.g., “j.smith,” “jay.smith,” or “j_smith.” When the caller speaks this part of the e-mail address, the IVR cannot distinguish between “jsmith” and “jaysmith,” or “j dot smith” and “jay dot smith.” The IVR may also encounter confusion if some callers say “jay dot smith” and others say “jay period smith.” Similarly confusing words can occur with the domain name, especially since many e-mail addresses have more than one extension, e.g., @business.co.au. The IVR may also have trouble interpreting the words that the speakers say, either because the speakers do not speak clearly or because of the accent or speed with which the address is spoken. Some people may speak the e-mail address using words, and others may spell the whole address out, and others may combine the two methods. In addition, because many parts of e-mail addresses are names and may actually be two or more words concatenated into one, it is difficult to match words using a standard dictionary.

The present invention improves upon the prior art by allowing a sender to use an information assistance service provider to send a message. The sending of the message may be initiated by calling the information assistance (e.g., directory assistance, 411) service provider directly or by transfer thereto as part of another call or series of transactions. The message includes at least first and second portions thereof, e.g., message overhead data versus message content or body. The first portion of the message includes data fields. For example, where the message comprises an e-mail, the message overhead data may include “envelope” information such as the e-mail destination address (“To” data field) and return e-mail address (“From” data field). There may also be other data fields for a carbon copy (CC) address(es), a subject line, a signature, and/or notes for attachment to the message body. In response to a request for sending a message from an information assistance caller, the information assistance service provider obtains first data concerning the first portion of the message, e.g., the message overhead data. The first data is then provided, along with a message identifier, to a message server for sending the message. The information assistance call is then connected to the message server through a network to allow the caller to communicate to the message server second data concerning the second portion of the message, e.g., the message content. The aforementioned message identifier is again provided to the message server in connecting the call to the message server, whereby the message server realizes the message by associating first data and second data based on the same message identifier. Message-identifying data, such as a message ID (distinct from the message identifier), may be added to the first data in order to keep track of the message.

In accordance with an aspect of the invention, part of the message overhead data, e.g., the “To” field, may be obtained from contacts folders (also known as private directories) associated with the caller, which are maintained by the information assistance service provider for the caller. Such contacts folders are identifiable, e.g., by the telephone number of the caller, which appears to the information assistance service provider as an automatic number identification (ANI) when processing the call. Where the data in the “To” field is new, the information assistance service provider may offer to update the appropriate contacts folder(s) with the new destination address. Similarly, the data in the “From” field (a return address) may be obtained from a user profile containing the caller's personal information and preferences, which may also be identified by the ANI.

The invention also includes the ability to facilitate a reply to a message sent using an information assistance service provider. As with the message, the reply also includes first and second portions, e.g., reply overhead data and reply message content. When submitting a request for a reply, message-identifying data are transmitted along with the request so that the information assistance service provider may refer to the original message and the message overhead data associated with that message. The reply may be in the form of a voice call or an electronic reply or a combination of the two. In a manner similar to that for sending a message, the information assistance service provider provides the first reply data and a reply identifier to the message server, and the recipient is connected to the message server through a network to communicate the reply content to the message server. The message server realizes the reply by associating the first and second reply data based on the same reply identifier. In addition, the caller can identify the preferred method of response.

In accordance with another aspect of the invention, information is automatically entered into the data fields of the message. In response to the request for sending a message from an information assistance caller, the information assistance service provider obtains an identifier related to the caller (a “caller identifier”), and then obtains data based upon the caller identifier. This data concerns the first portion of the message, e.g., the data fields of the message overhead data. Part of the message overhead data, e.g., the “To” field, may be obtained from the contacts folders associated with the caller. In addition to being identifiable by the ANI, the contacts folder may be identifiable by a mobile identification number (MIN) if the call comes from a mobile device. The caller (and associated contacts folders) may also be identifiable by a voiceprint or a code provided by the caller. Similarly, the return address (the “From” field) may be obtained from the user profile containing the caller's personal information and preferences, which may also be identified by the ANI or MIN. The profile may also include a history of entries for each data field for that caller, from which the current data field entries may be chosen.

A further aspect of the invention is the ability to use Starback®-type features, which allow a caller to connect to a destination terminal (e.g., the aforementioned message server), thereby disconnecting the caller from the information assistance service provider, and yet be able to summon the service provider for further assistance by initiating a predetermined signal by pressing, e.g., the “*” (star) key on a telephonic device.

A further aspect of the invention is the ability to use an Autoback® feature, which reconnects the caller to the information assistance service provider if an attempted call to a destination party cannot be completed, e.g., if there is a busy signal, a ring-no-answer condition, or a network communication problem. The messaging feature of the present invention may then be offered to such a caller who is reconnected to the information assistance service provider in order to communicate with the destination party via a message.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates an arrangement for sending a message using an information assistance service provider in accordance with an embodiment of the present invention;

FIGS. 2A-2C are examples of message data entry templates as viewed by an information assistance service provider in accordance with an embodiment of the present invention;

FIG. 3 illustrates an information assistance service provider and a servicing platform for providing an information assistance service;

FIG. 4A is a flowchart depicting a routine for sending a message to a destination in accordance with an embodiment of the present invention;

FIG. 4B is an example of a message as viewed by the recipient in accordance with an embodiment of the present invention;

FIGS. 5A and 5B jointly illustrate another arrangement for sending a message using an information assistance service provider in accordance with an embodiment of the present invention; and

FIGS. 6A and 6B illustrate an arrangement and a flowchart for replying to a message using an information assistance service provider in accordance with an embodiment of the present invention.

### DETAILED DESCRIPTION

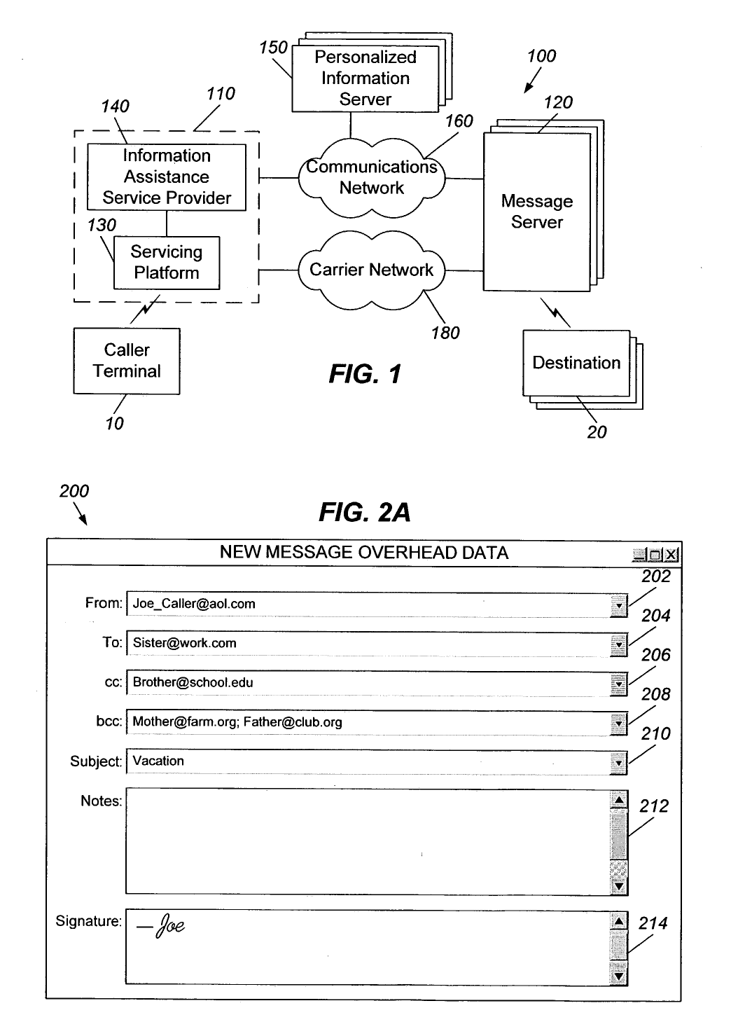

FIG. 1 illustrates arrangement 100 in which a caller initiates an information assistance call from caller terminal 10, which is routed to, say, information/call center 110 via one or more carrier switches in a carrier network, e.g., a public switched telephone network (PSTN), a wireless telephone network, etc. Caller terminal 10 may comprise a wireless telephone, wireline telephone, personal digital assistant (PDA), computer, or other communication device. In a typical directory assistance call, a caller identifies to the operator the name and address (sometimes city or area code) of a party whose telephone number is desired. In response, the operator locates the desired destination telephone number using, e.g., a computer database. The destination number is then provided to the caller, e.g., by a computerized voice server which provides automated voicing of the number, and the caller is afforded an option to be connected to the destination number without the need of first terminating the directory assistance call.

Information assistance is an extension of directory assistance. In addition to connecting a caller to a destination number, information assistance operators can provide concierge-type services such as a restaurant guide and reservation service, event ticketing and reservation service, hotel reservation and availability service, travel or flight reservation and ticketing services, ordering specific items such as flowers or food delivery, arranging transportation, and accessing entertainment guides. The use of information assistance to provide such concierge-type services is disclosed, e.g., in co-pending, commonly-assigned application Ser. No. 09/520,306, “Technique for Providing Information Assistance Including Concierge-Type Services,” filed Mar. 7, 2000, which is incorporated herein by reference. The term “operator” used herein broadly encompasses entities that are capable of providing information assistance in a telecommunications environment, including, without limitation, human operators, voice response/recognition capabilities, web-/WAP-enabled operator services, and other automated and electronic access.

In addition, a caller who subscribes to an information assistance service may have one or more user profiles on file with the service that include information pertaining to and about the caller, including his/her preferences. Such preferences may specify use of a special skilled operator to answer the caller's call, and include such personal information as favorable restaurants, movies, sporting events, or hobbies. They may also define options of various assistance service features which may include, e.g., the above-described concierge-type features whereby the user can make restaurant reservations, purchase tickets, etc.; a second feature whereby the user is provided with a listing number before he/she is connected to the listing number; and a third feature whereby the user can obtain directions to a listing address. Similarly, for example, the methods of delivery (e.g., e-mail, paging, short message service (SMS), etc.) of (i) a confirmation of a reservation or purchase, (ii) a listing number, and (iii) directions to the user may be specified in the user profile as well. The user profile(s) in this instance is maintained in association with, and is identifiable by, the caller's telephone number.

The caller may also subscribe to a personalized information management service as part of the information assistance service described, e.g., in U.S. Pub. No. 2002/0055351 A1, published May 9, 2002, incorporated herein by reference. For example, the information management service maintains for the caller contacts folders (also known as private directories), appointments folders, to-do lists, etc. The caller may access, through the information assistance service, contact information, appointment information or a to-do list item in the respective folders associated with the caller or his/her telephone number. In particular, a contacts folder contains contact information, such as a telephone number(s), an address(es), and e-mail address(es), for people and/or organizations. A user may have separate contacts folders for different purposes, such as a personal contacts folder, business contacts folder, sports team contacts folder, etc. An appointments folder contains a user's appointment and/or calendar information, and a user may similarly have separate appointments folders for different purposes. Other folders may include events, products, and other information that may be tailored to the needs of an individual or a group, e.g., a corporation, an organization, or a collection of people having a common interest. These folders may be identified by the user's telephone number, and are accessible by each information assistance operator through personal information servers 150. The user may have specific rights with respect to a folder, e.g., owner, administrator, read-only, etc. When the user accesses a folder through the operator, the operator becomes an alter ego of the user and is subject to the same rights as the user with respect to the folder. The user may create, maintain, or access a contacts, appointments, or other folder via the Internet or other communications means, or through an operator who in turn may create, maintain, or access the folder on behalf of the user. If using an operator, the user calls a designated access number, and the call is routed to an information/call center 110 where an operator attends to the call. While or before the user communicates to the operator his/her needs, the operator accesses one or more personalized information servers 150 through communications network 160, e.g., a wide area network (WAN) or the Internet. In response, server 150 presents on the operator's terminal various graphical user interface (GUI) dialog boxes, e.g., “login” (for confirming the user's identity by User ID and password), “home” (listing the user's contacts, appointments, and other folders), “edit” (for editing specific folder contents), and “view” (for viewing folder contents), for interacting with the operator.

The present invention is directed to providing an information assistance service to assist a user in sending a message to a desired recipient. The recipient may be identified by an e-mail address, but may also be identified by addresses associated with other messaging systems, including a wireless telephone, pager, SMS, personal digital assistant (PDA), personal information management (PIM) system, etc.

In this illustrative embodiment, users of a particular telephone carrier may dial, speak or otherwise communicate predetermined access digits, access codes or retail numbers, or input a predetermined address or URL (uniform resource locator) established by the carrier to access information/call center 110. For example, the predetermined access digits may be “411,” “*555,” “555-1212,” “00,” etc. On learning one such access digit sequence initiated from a caller's communications device, a switching system of the caller's telephone carrier in a conventional manner routes the information assistance call to information assistance service provider 140 through a carrier network. In this instance, the carrier network switches the call to servicing platform 130, which is associated with service provider 140. Once connected to information/call center 110, the caller indicates to service provider 140 his or her desire to send a message to a destination, which can be associated with any entity, e.g., a person, a business, an organization, etc., that is accessible via a messaging system. In accordance with an aspect of the invention, service provider 140 determines “message overhead” data, as distinguished from the message content or body information. Such message overhead data may include “envelope” information data fields such as the destination address(es) (e.g., e-mail address) to which the message is to be delivered (the “To” field), destination name, sender's name and return address (e.g., return e-mail address or “From” field). Message overhead data may also include data fields for a carbon copy (CC) and/or a blind carbon copy (BCC) address(es), a subject line, a signature, and/or notes for attachment to the message body. A message may be sent using “indirect addressing,” in which the address name stays the same, but the person or persons covered by the address may differ, for example when a destination address includes a mailing list whose contents may change from day-to-day (e.g., “sales force”). In order to track the message, service provider 140 generates message-identifying data or a message ID and includes it as part of the message overhead data. The message ID is used for identifying the message and may be unique, although such uniqueness is not required so long as the message ID combined with other message overhead data uniquely identifies the message. The message overhead data as determined are transmitted to one or more message servers 120 through communications network 160. In addition, service provider 140 routes the caller's call via carrier network 180 (e.g., PSTN), comprising one or more switches, trunks, and central and end offices, to message servers 120 for the caller to communicate thereto the message content to complete the message. As an example, message server 120 may comprise the prior art Trekmail server described before. Message server 120 in a conventional manner sends the complete message (i.e., the message overhead data plus message content) to one or more appropriate destinations 20. Depending on the destination address used, the message may be sent over a communications network or a carrier network or some combination of the two. This carrier network and communications network may be the same as or different from carrier network 180 and communications network 160.

There are several ways to determine the return and destination addresses. One is for the caller to provide the exact addresses to service provider 140. In the case of an e-mail address, the caller may pronounce the address in words or spell it out, so that an operator in service provider 140 is able to transcribe the address.

Another way is more automatic. When the information assistance call is received by servicing platform 130, the latter in a well-known manner derives, from the signaling associated with the call, the caller's telephone number from which the call originates, also known as an ANI (automatic number identification) (or an MIN (mobile identification number) if the call originates from a mobile number). Alternatively, the caller may be identified by the caller's name, telephone number, a code provided by the caller, by the caller's voiceprint, or by other means. If the caller is a subscriber to the aforementioned personalized information management service, the operator's terminal screen will attempt to automatically populate the return and destination address fields based on information in the caller's contacts folder and/or personal profile. Like the contacts folders, the user profile in this instance is identifiable by the ANI, and can be retrieved in a manner described below.

There are a number of ways for the automatic field population to work. One is to automatically populate each data field with the last entry used. Past entries may be recorded by the information assistance service center and may be kept in the caller's profile. Data sources may be specified in a Personal Profile. If the profile keeps track of the frequency of past-used entries, another method is to automatically input the entry that has been used most in the past for that data field. Variations to this latter method may determine frequency based on the time of day or the ANI from which the caller is calling. If the call occurs during the day, there may be one set of entries more frequently used during working hours, for instance, whereas during the evening, more personal entries may be used. Similarly, if the ANI is associated with the caller's workplace, then a work-related entry would automatically populate the field rather than a more personal entry, which might be used if the ANI is associated with the caller's home.

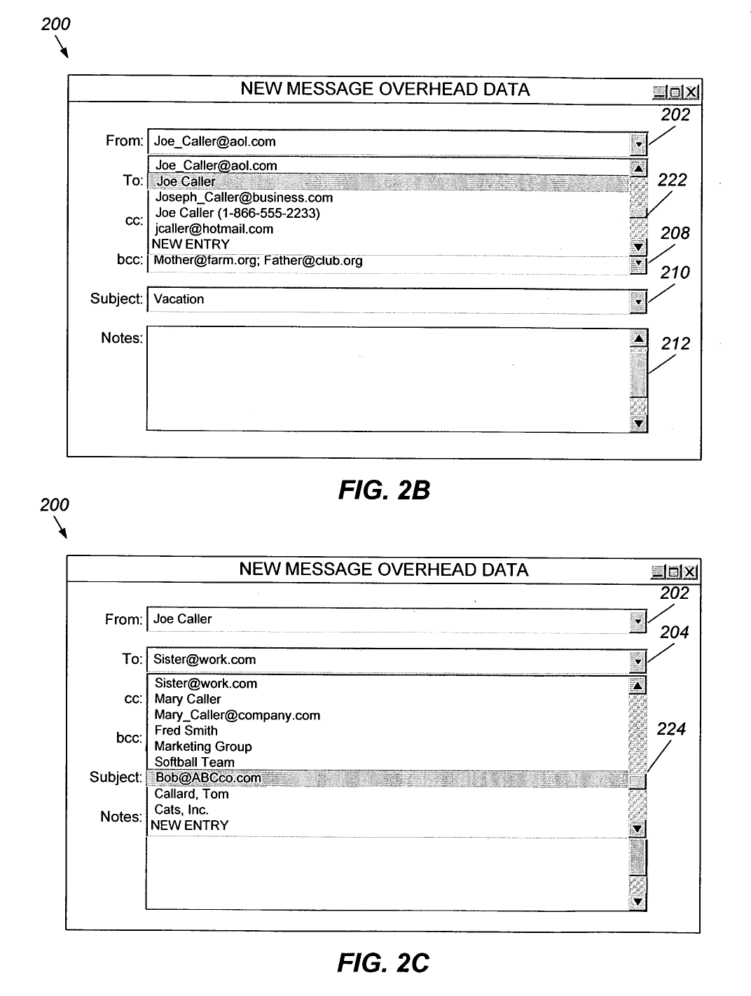

These methods are illustrated in FIG. 2A, which shows a template on a terminal screen for use by the information assistance service provider in entering message overhead data. Boxes 202-214 are message data fields indicating return, destination, CC, and BCC addresses, as well as subject, notes, and signature fields. These fields are automatically populated with, as shown in this example, the entries used in the previous message sent by the fictional user, “Joe Caller.” Alternatively, as mentioned above, each field may be automatically populated with the entry most frequently used by the caller. The operator can read to the caller the entries that have been automatically entered. If any entry is not what the caller desires, the caller indicates which field or fields should be changed. If the return address (“From” field) is incorrect, the operator can click, with a mouse or other similar pointing device, on the arrow on the data field box (dialog box) containing the field entry and activate drop-down box 222, as shown in FIG. 2B. Here, drop-down box 222 includes alternative entries for the return address field. They may be organized in a number of ways: most recently used, most frequently used, alphabetical, etc. The last entry may be called “NEW ENTRY,” which can be used by the operator to begin typing a different entry provided by the caller. In the example in FIG. 2B, the different return addresses may indicate the possible reply-to addresses used by the caller, depending on how the caller wants to present him- or herself to the recipient. If the caller is sending a personal e-mail, the caller's name or a personal return address may be used (e.g., Joe_Caller@aol.com), whereas if the caller is sending a business-related e-mail, a work address may be used (e.g., Joseph_Caller@business.com). In addition, because the message is being sent using the information assistance service provider, the caller's return address can be anonymous (e.g., Joe Caller), with replies being sent to the information assistance service provider rather than directly to the caller.

Similarly, if the destination address (“To” field) is incorrect, the operator can activate drop-down box 224, as shown in FIG. 2C. Drop-down box 224 illustratively includes alternative entries for the destination address field, ordered by recent use, frequency of use, alphabet, or a combination of these. For example, drop-down box 224 may first include the five most frequently used entries, and below that may list alphabetically the entries from the caller's contacts folders. Thus, the caller may communicate to the operator that he/she wants to send an e-mail to a destination party, e.g., Bob at ABC Company. In response, the operator searches drop-down box 224 for the desired contact information, including, e.g., Bob's e-mail address in this instance (Bob@ABCco.com). The operator can read back the likely address, and, upon confirmation by the caller, can accept the address by clicking on it. If none of the entries listed is what the caller desires, the operator can choose “NEW ENTRY,” automatically blanking field 204, and begin typing a different entry provided by the caller. As the operator begins to type the new entry, the field accesses lookup tables and performs “auto completion,” which tries to automatically complete the entry. The lookup tables can include addresses from the caller's profile and contacts folders, as well as public databases, e.g., public e-mail address directories, accessible to the information assistance service center. Such databases may be standalone (e.g., on CD-ROM) or may be accessible via the Internet or other public or private network. While typing, the system provides auto completion possibilities to minimize the amount of typing performed by the operator. In addition, once the address is entered and confirmed, the operator can add to the appropriate contacts folder that destination name and address as new contact information.

As mentioned before, the destination address is part of the message overhead data. Other message overhead data may include CC and BCC addresses, a subject concerning the message to be sent, notes, and a signature. Each of these fields may be automatically populated in the manner used for the return and destination addresses. The automatic entry for different fields may be based on different criteria—e.g., most recently used for addresses, most frequently used for subject, etc. If the initial automatic entries are not correct, the operator may click on the drop-down lists to choose other entries, or type new entries whose entry into the data fields may be facilitated using auto completion. Similarly, the caller's signature, which may include the caller's name and/or a stylized signature representing the caller and which may be stored in the user profile as well, is automatically entered according to a preferred criterion (e.g., last used, default, most frequently used), but other choices may be made, depending on the type of message sent and the caller's preferences.

Automatically entering data is advantageous because there is less typing for the operator to do. This results in less time spent by the operator servicing the call. Less typing also results in fewer typing mistakes made. In addition, by using entries retrieved from past usage, the entries (such as e-mail addresses) are more reliable, having already been demonstrated to work (assuming the message was not returned as undeliverable).

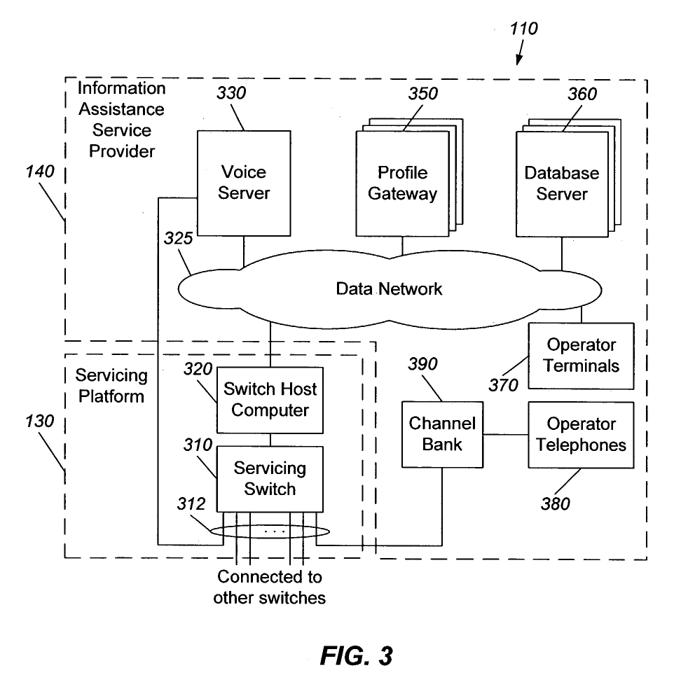

FIG. 3 illustrates information/call center 110, which may be configured to include information assistance service provider 140 together with servicing platform 130. It should be noted that even though both service provider 140 and servicing platform 130 appear in the same figure, they may or may not be located in the same geographic area. Servicing platform 130 includes servicing switch 310 having T1 spans 312 for connection to voice server 330, channel bank 390, and one or more carrier networks. In an alternative embodiment, voice information may be packetized and transmitted pursuant to a voice over Internet protocol (VoIP) through a packet-switched network, e.g., the Internet, to information/call center 110. Servicing switch 310 may receive an incoming information assistance call from a carrier switch in a carrier network. Servicing switch 310 may also be used to place an outgoing call onto a carrier network, which may be different from the carrier network used for the incoming call.

Channel bank 390 in service provider 140 is used to couple multiple operator telephones 380 to servicing switch 310. The operators in information/call center 110 are further equipped with operator terminals 370, each of which includes a video display unit and a keyboard with an associated dialing pad. Operator terminals 370 are connected over data network 325 to one or more database servers 360, switch host computer 320, personalized information servers 150, etc. Switch host computer 320 and voice server 330 are also connected to data network 325. By way of example, data network 325 includes a local area network (LAN) supplemented by a number of point-to-point data links. Through data network 325 and routers (not shown), components of information/call center 110 are also connected to communications network 160.

Servicing switch 310 is conventional and supports digital T1 connectivity. The operation of servicing switch 310 is governed by instructions stored in switch host computer 320. In this illustrative embodiment, servicing switch 310 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, voice recognizers, dual-tone multi-frequency (DTMF) generators/detectors, or conference units, depending on the demand placed on information/call center 110 and servicing switch 310 for each corresponding function.

An incoming information assistance call is received by servicing switch 310 in information/call center 110, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 320 or elsewhere in information/call center 110. In other instances, other distribution logic may be utilized, such as skills-based routing or a priority scheme for preferred users.

Operators may use database server 360 to provide information assistance including searching internal and external databases (including those accessible via the Internet) for a user's desired party and determining the appropriate destination address of the party.

Voice server 330 (also known as a “voice response unit” or “VRU”) is used to play the constant repeated parts of an operator's speech, namely, the various greetings and signoffs (or closings). Voice server 330 is connected via data network 325 to switch host computer 320 and via one or more T1 spans 312 to servicing switch 310. Voice server 330 may comprise a general-purpose computer and one or more voice cards for voice recognition, voice recording and playback, and call progress analysis. At appropriate stages in a call progression, switch host computer 320 initiates a voice path connection between voice server 330 and servicing switch 310 such that the user, or the user and the operator, are able to hear whatever pre-recorded speech is played on that connection by voice server 330. Computer 320 then instructs voice server 330, via data network 325, what type of message to play, and passes data parameters that enable voice server 330 to locate the message appropriate to the call state.

Data network 325 may further connect to one or more profile gateways 350. Each profile gateway 350 provides access to a user profile, which may include personal information and the subscriber's preferences. Such personal information and preferences may include the subscriber phone number, fax number, e-mail address, preferred restaurant and dining time, preferred mode of delivery of information to him/her, dietary requirements, likes and dislikes, past logged activities, etc. When the information assistance call is received by servicing switch 310 in information/call center 110, switch 310 derives, in a well-known manner, from the call setup signaling associated with the call the aforementioned ANI, i.e., the telephone number from which the call originates. Switch host computer 320 then requests via a profile gateway 350 any profile identified by such an ANI. An embodiment of profile gateway 350 may include a data network interface, a communications interface, a processor, and memory. Profile data may be input and updated (e.g., via Internet web pages or operator) through a remote profile manager (not shown). Copies of the profile data are distributed to the profile gateways in various information/call centers (e.g., center 110) connected via communications network 160. In response to a request for a profile, the processor in the profile gateway searches the memory (which may include disks, caches, and volatile and nonvolatile memories) for the profile identified by the ANI. When the operator answers the call, computer 320 communicates to components in service provider 140 and, in particular, the operator through terminal 370 any profile data pertinent to the handling of the call. In this instance, the caller requests the operator's assistance to send a message, e.g., an e-mail message, to a desired destination. In response, the operator brings up on terminal 370 template 200 to collect the message overhead data as described before. User profile data, such as the caller's e-mail address, signature, etc., and previous destination, CC, and BCC addresses and subjects and notes may populate the template automatically, thereby minimizing the need for interrogation and transcription by the operator. In addition, as described before, the template may be populated with other possible destination e-mail addresses from the caller's contacts folders identified by the ANI, and/or other resources, and the operator obtains from the caller the desired address. Also as described before, the caller's choice of return address can reflect the caller's desired method of reply. Such information includes a reply-to address or telephone number as well as whether replies should be directed to the caller directly or to the service provider (in order to maintain anonymity). Reply information that the caller permits the recipient to view is included as part of message overhead data. Information the caller would like to remain hidden from the recipient (such as the caller's e-mail address or telephone number) may be provided to the service provider and/or placed in the caller's profile, and it is retained by the service provider for relaying replies.

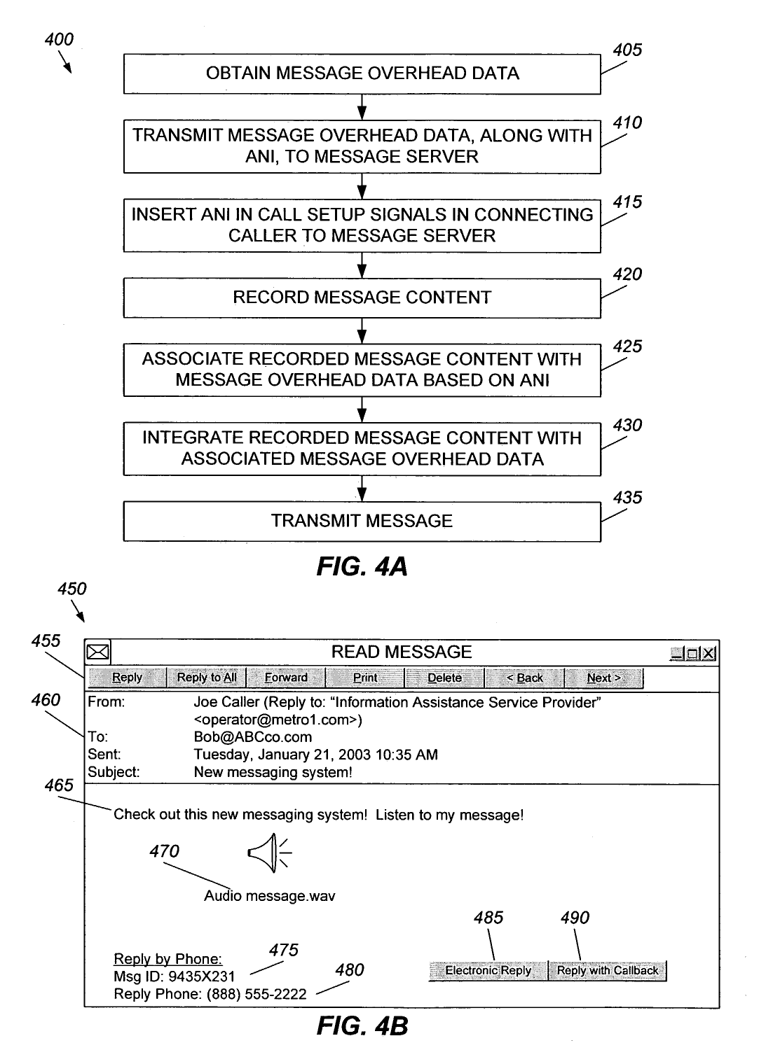

Referring to FIG. 4A, once the message overhead data are collected, the operator causes the data, formatted in accordance with a predetermined protocol, to be transmitted to a message server 120 through communications network 160. In this instance, the ANI associated with call terminal 10 is added to the message overhead data for its identification. The operator also causes the caller's call to be connected to a message server 120 through carrier network 180, thereby disconnecting the call from service provider 140. Host computer 320 is programmed to insert the ANI previously determined thereby in the call setup signals for establishing the caller's connection to message server 120 through servicing switch 310. In this instance, message server 120 relies on the ANI (or other identification mechanism) inserted in the call setup signals to locate the previously received message overhead data concerning the caller's message, which is identifiable by the same ANI. After the caller communicates the message content through the established connection to server 120, the latter integrates such message content with the identified message overhead data, thereby realizing a complete message to be sent. The message content may contain multimedia (e.g., audio, video and/or text) information, depending on the capability of terminal 10 used by the caller, and the media supported by server 120.

FIG. 4A is a flowchart 400 illustrating a routine for sending a message to a desired destination using an information assistance service in accordance with an embodiment of the present invention. The caller initiates an information assistance call from caller terminal 10, connected to information/call center 110. Service provider 140 obtains message overhead data in step 405. Once the message overhead data is obtained, service provider 140 in step 410 transmits the data, along with the ANI (or other identification means) associated with terminal 10, to message server 120.

In step 415, the operator connects caller terminal 10 to a message server 120 through servicing switch 130, and in establishing the connection to message server 120, host computer 320 inserts the ANI associated with terminal 10 in the call setup signals as mentioned before. As a result, service provider 140 in this instance is disconnected from terminal 10. However, one or more DSPs in servicing switch 310 may be programmed to detect any predetermined signals generated by the caller on the connection between caller terminal 10 and servicing switch 320. For example, the DSPs may be programmed to monitor the connection for particular DTMF signals (e.g., “*” key) or other signals (e.g., speech) to implement a Starback® feature disclosed, e.g., in U.S. Pat. No. 5,797,092, hereby incorporated by reference. For example, the Starback® feature allows the caller to be reconnected to service provider 140 for further information assistance upon pressing a “*” (star) key on terminal 10.

In step 420, message server 120 prompts the caller to record the message content. For a voice message, this may be done in the manner described above with respect to the Trekmail system. For a video message, the caller may have a videophone or a camera, such as a “web cam,” that takes video pictures of the caller with or without sound. These video pictures may be transmitted directly over the phone connections to message server 120 or may be converted to a video file and then transmitted over the phone connections to message server 120. For a text message, a user may use a well-known text input device to enter and transmit the message over the phone connections. Alternatively, the caller may dictate a message to the operator before being connected to message server 120, and that dictated message could be transmitted to message server 120 along with the message overhead data obtained in step 410. Another method of transmitting a text message is to use a speech-to-text converter in message server 120, which converts the caller's speech into a text message. A message may include more than one kind of message format (e.g., audio and text).

In step 425, message server 120 in this illustrative embodiment relies on the received ANI in the call setup signals to associate the recorded message content with the previously received message overhead data identified by the same ANI, i.e., the ANI associated with terminal 10. However, in an alternative embodiment where communications are in accordance with the VoIP, both the message content and message overhead data traverse the same communications network 160 in the form of data packets identifiable by the IP address of terminal 10. As a result, in the alternative embodiment carrier network 180 and the aforementioned ANI are not needed.

In step 430, message server 120 integrates the recorded message content with the associated message overhead data, thereby realizing a complete message to be sent. In step 435, message server 120 transmits the message to the destination address indicated in the message overhead data. If the destination address is an e-mail address, the message server may deliver the message over a communications network.

FIG. 4B is an example of a message 450 formed in accordance with the invention, as viewed by the recipient in an e-mail format. The recipient is shown in block 460 along with the sender's name, a “reply-to” address, the date the message was sent by message server 120, and the subject. In this case, the sender has chosen not to provide a return e-mail address or telephone number, so information assistance service provider 140 provides the reply address in the “From” field. The date is generated in a conventional manner by the e-mail system when the message is sent by message server 120.

Message body 470 in this example contains an audio message, recorded by the sender after he or she was connected to a message server 120. Notes 465 could have been included as part of the message overhead data (and thus obtained by service provider 140) or could be included as part of message body 470 (and thus obtained by message server 120) as previously described.

Message ID 475, reply phone number 480, electronic reply button 485, and reply with callback button 490 are displayed at the end of message and are included in order to facilitate a reply, the mechanics of which are described below.

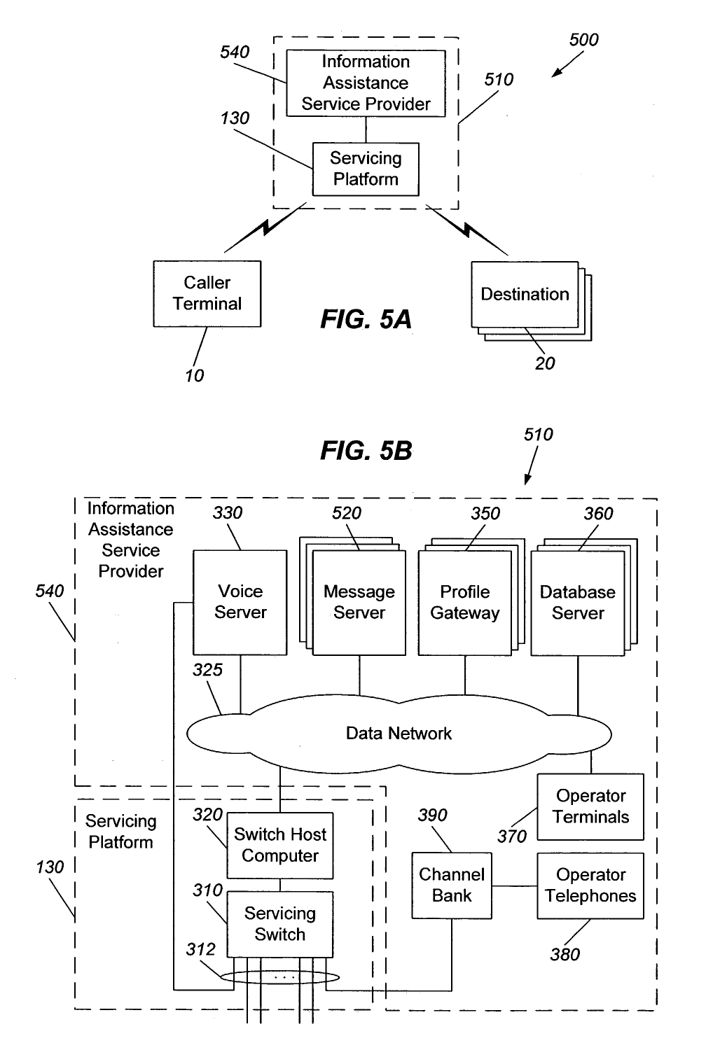

FIGS. 5A and 5B jointly illustrate a second arrangement denoted 500 in accordance with the invention. In this second arrangement, the message server is made part of information/call center 510, which is similar to information/call center 110 except for the additional message servers 520 internal to information assistance service provider 540. When a caller in this instance makes a call requesting to send a message to a desired destination, the operator provides to a message server 520 the message overhead data, which the caller may furnish or which the operator may find in the caller's contacts folders, profiles or other internal or external databases. The caller is then prompted by message server 520 to record the message content to complete the message. In a conventional manner, the completed message is sent to the desired destination indicated in the message overhead data. Thus, in arrangement 500, use of internal message servers 520 obviate the need for exporting any message overhead data to an external message server or transferring the caller's call to the same.

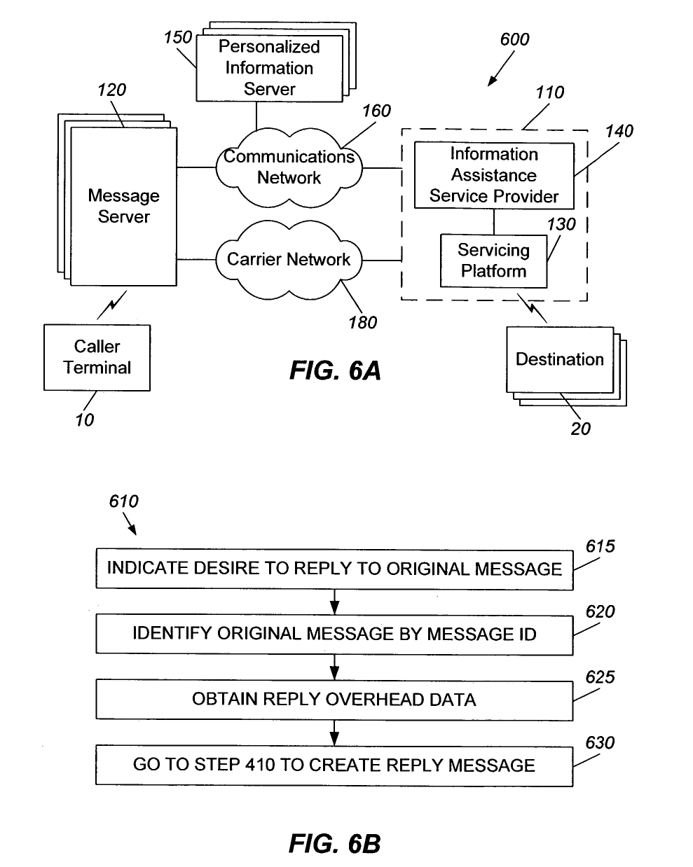

The invention also includes facilitating a reply to be made to the message. FIG. 6A illustrates one such arrangement 600 and FIG. 6B is the accompanying flowchart 610. (Note that arrangement 600 may also be arranged as in FIGS. 5A and 5B, in which the message server is integrated with the information assistance service provider.) Illustratively, the recipient may reply to the message by phone, electronically, or by a combination of these methods. In addition, the sender may identify the preferred method of response.

In each of these methods, the recipient indicates in step 615 the desire to reply to the original message. The original message is then identified by its message ID in step 620. “Reply overhead data,” analogous to message overhead data, are then obtained in step 625. The steps shown in flowchart 400 are then followed to complete the reply.

More specifically, replying by phone involves calling reply phone number 480. Depending on the sender's preferences, reply phone number 480 is linked to service provider 140 and may be a toll-free number (as indicated in FIG. 4B). Once connected to service provider 140, the recipient provides the message ID, and service provider 140 accesses the message overhead data from the sent message, including the sender's destination address to where the reply should be sent. Given the message ID, service provider 140 is also able to access from a message server 120 the original message content itself. From this point, the procedure for sending a reply is similar to that for sending an original message. Service provider 140 obtains the requisite reply overhead data from a number of sources, e.g., the sent message, the recipient, and/or the recipient's profile (if available). (For example, the recipient may want to use as a reply-to address the same address used by the sender as a destination address.) These values are automatically entered into a reply message overhead data template in a manner analogous to that used for the original message overhead data. Reply overhead data include the same types of information as message overhead data, including a reply message ID. Because service provider 140 can access the original message from a message server 120, reply overhead data may also include the original message. Alternatively, the original message may be appended to the reply message by message server 120. As with the original message, the reply overhead data are transmitted with the recipient's ANI (as a message identifier) to a message server 120, and then the recipient is connected to the message server to record the reply. Once the reply is recorded, it is associated with the reply overhead data and the content and overhead data are integrated into a complete reply, which is transmitted to the sender.

Instead of replying by telephone, the recipient may reply electronically. Electronic reply button 485 is included in message 450 for this purpose. Illustratively, clicking on electronic reply button 485 invokes the reply system of the electronic messaging system (as exemplified by buttons 455), but adds some information necessary for replying within the context of a message transmitted through a service provider and a message server. Thus, by clicking on electronic reply button 485, the message ID is automatically included in the reply to service provider 140, in accordance with a pre-agreed-upon protocol. In responding electronically, there may be no need for the recipient to interact with a human operator or to communicate via the telephone network in order to access service provider 140 or message server 120. Instead, the reply (which may include the original message) is transmitted over a communications network to the information service provider. This communications network may be the same as or different from communications network 160. Service provider 140 collects reply overhead data, such as the recipient's address, from- information included in the reply and obtains other reply overhead data, such as the sender's address, by using the message ID transmitted with the reply to access the original message overhead data. An electronic reply may include reply message content that is then forwarded by service provider 140 to message server 120.

If the recipient does not want to reply electronically, the recipient may be given the choice to reply with a callback. In such a scenario, the recipient replies using reply button 490, which communicates with the information assistance service provider via a communications network, but indicates a desire to receive a callback- from the operator. Clicking on reply-with-callback button 490 opens up a dialog box requesting the recipient's callback telephone number. The recipient then transmits to service provider 140 the callback telephone number, transmitting along with it the message ID. Service provider 140 receives the information, calls up the message overhead data based on the message ID, and calls the recipient at the callback number to establish a telephone connection. After obtaining the relevant reply overhead data, service provider 140 connects the recipient to a message server 120, and the recipient records a reply message in the manner described previously.

There are a number of advantages in using the reply-with-callback function rather than merely calling the service provider as described above. First, because the message ID is transmitted along with the reply, the recipient does not have to dictate the message ID to the service provider, lessening the chance of making a mistake in the dictation or transcription. Second, the reply-to number provided with the message may be a toll call, whereas replying with a callback does not result in the recipient being charged for the reply call. Third, using reply-with-callback allows the original message to be appended to the reply without the service provider having to retrieve it from message server 120, thus reducing the steps needed to complete a reply.

The present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

For example, the invention equally applies regardless of whether feature group D (FGD) type signaling, SS7 out-of-band signaling, or other signaling is used for communications between carrier switches and switch 310 of FIG. 3.

In addition, the messaging service in accordance with the invention may be provided as a service to a caller who had been connected to a called party through use of an information assistance service, and then activated Starback® to return to an operator. In a further variation, the caller who had been connected to a called party through use of an information assistance service may invoke further information assistance during the call, as described in co-pending, commonly-assigned Provisional Application Serial No. 60/414,965, filed Sep. 30, 2002, incorporated herein by reference. In that variation, either the caller or the called party may summon the operator during a call, the operator is conferenced in, and, at the request of either party, the operator may then connect the call to message server 120. In such a way, either or both parties to the call may record a message. Identifying information sent by information/call center 110 to message server 120 allows for the message to be associated with destination address information obtained by service provider 140 from either the caller or called party. Although this process is described with respect to information/call center 110 in arrangement 100, it could easily be handled using information/call center 510 and arrangement 500 in FIG. 5A.

In addition, the messaging service in accordance with the invention may be provided as a service to a caller who has been reconnected to the information assistance service because the call to a destination party encountered a busy signal, ring-no-answer, network communication problem, or other non-completion signal. The feature that automatically reconnects the caller to the information assistance service in event of non-completion of a call is called Autoback® and it is described, e.g., in U.S. Pat. No. 6,456,709 (“the '709 patent”), hereby incorporated by reference. The '709 patent discloses that when the caller is reconnected, the caller is provided with a menu of directory assistance service options, including the option to continue monitoring the ring tone (if a ring-no-answer condition exists) or to re-dial the same number (if a busy signal exists). The present invention provides another directory assistance service to callers returned to the operator if their call is not completed. In such a case, the caller can opt to send a message to the called party. The message may be sent, e.g., via e-mail and may comprise, e.g., a voice or text message, as described above.

One implementation of this aspect of the invention is as follows. The caller initially calls the information assistance service for connection information concerning a desired called party. As part of the service, it attempts to complete the call to the called party for the caller, but the call encounters a ring-no-answer condition or a busy signal or other indication of an incomplete call. One or more processors within servicing switch 310 detect that the call is incomplete and reconnect the caller with the information assistance service. If a live operator comes on, the caller can request the operator's assistance to send an e-mail message to the called party. To that end, the caller may relay to the operator the message overhead data, including the e-mail or other destination address of the called party (which may come from the caller's personal profile or contacts folder), the caller's name and return address, the subject of the message, and CC or BCC addressees. The message overhead data are transmitted, along with the ANI, to message server 120, the caller records the message via the message server, the message server appends the message overhead data to the message and transmits the full message in a manner described above.

If the information assistance service is automated, a messaging option can be added to the voice response unit (VRU) menu described in the '709 patent. In such a case, the caller chooses the messaging option and the VRU (voice server 330) prompts the caller for message overhead data. For receiving some message overhead data, such as the destination address, that is more easily understood and transcribed by a human, the VRU may switch the caller to a live operator.

One advantage of this aspect of the invention is that if the reason for a busy signal is that the called party is online using the same telephone line, sending a message in this way still allows the caller to communicate with the called party. Similarly, if the called party is not at the called number (a ring-no-answer condition), a message sent to a PDA or wireless telephone with an e-mail capability may allow the caller to communicate with the called party more quickly than if the caller merely left a standard answering machine message.

Information/call centers 110 and 510 are disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors. Also, some blocks (e.g., 120, 150, 350, 360, etc.) can comprise more than one unit.

What is claimed is:

1. A method for sending a message using an information assistance service provider, comprising:
receiving by the information assistance service provider a call from a caller, the call including a request for sending a message, the message including at least first and second portions thereof;
in response to the request, obtaining first data concerning the first portion of the message;
providing the first data and a message identifier to a message server for sending the message;
connecting the call to the message server through a network to allow the caller to communicate to the message server second data concerning the second portion of the message; and
providing the message identifier to the message server in connecting the call to the message server,
whereby the message server realizes the message by associating first data and second data based on the message identifier.

2. The method according to claim 1, wherein the first data includes a destination address of the message.

3. The method according to claim 1, wherein the message includes an e-mail, and the destination address includes an e-mail address.

4. The method according to claim 1, wherein the second data includes at least one of audio, video, and text data.

5. The method according to claim 1, wherein at least part of the first data is obtained by searching a source accessible by the information assistance service provider.

6. The method according to claim 5, wherein the source is associated with the caller.

7. The method according to claim 6, wherein the source includes one or more contacts folders maintained by the information assistance service provider.

8. The method according to claim 1, wherein the message identifier is associated with a communications device from which the call originates.

9. The method according to claim 8, wherein the communications device includes a telephonic device, and the message identifier includes a telephone number.

10. The method according to claim 1, wherein the first data and second data are transmitted pursuant to a voice over Internet protocol (VoIP).

11. The method according to claim 1, wherein the network comprises a telephone network.

12. The method according to claim 1, wherein the network comprises at least part of the Internet.

13. The method according to claim 1, wherein the call is reconnected to the information assistance service provider after the call, which was originally destined to a device associated with a recipient of the message, is not completed.

14. The method according to claim 1, further comprising facilitating a recipient of the message to reply to the message.

15. The method according to claim 14, wherein the caller specifies the preferred reply method.

16. A method for use in a system for sending a message through an information assistance service provider, comprising:
receiving data including a first message identifier from the information assistance service provider;
recording message content associated with a second message identifier; and
transmitting the message to a destination indicated in the data, the message including the message content when the first message identifier corresponds to the second message identifier,
wherein the information assistance service provider receives a call from a caller, obtains the data, and provides a connection between the caller and the system.

17. The method according to claim 16, wherein the message content includes at least one of audio, video, and text data.

18. The method according to claim 16, wherein the data includes a destination address.

19. The method according to claim 18, wherein the message includes an e-mail, and the destination address includes an e-mail address.

20. The method according to claim 16, wherein at least part of the data is obtained from the caller during the call.

21. The method according to claim 16, wherein at least part of the data is obtained by searching a source accessible by the information assistance service provider.

22. The method according to claim 21, wherein the source is associated with the caller.

23. The method according to claim 22, wherein the source includes one or more contacts folders maintained by the information assistance service provider.

24. A system for sending a message using an information assistance service provider, comprising:
an interface for receiving by the information assistance service provider a call from a caller, the call including a request for sending a message, the message including at least first and second portions thereof;
a first mechanism responsive to the request for obtaining first data concerning the first portion of the message;
a device for providing the first data and a message identifier to a message server for sending the message; and
a second mechanism for connecting the call to the message server through a network to allow the caller to communicate to the message server second data concerning the second portion of the message, the message identifier being provided to the message server in connecting the call to the message server,
whereby the message server realizes the message by associating first data and second data based on the message identifier.

25. The system according to claim 24, wherein the first data includes a destination address of the message.

26. The system according to claim 25, wherein the message includes an e-mail, and the destination address includes an e-mail address.

27. The system according to claim 24, wherein the second data includes at least one of audio, video, and text data.

28. The system according to claim 24, wherein at least part of the first data is obtained by searching a source accessible by the information assistance service provider.

29. The system according to claim 28, wherein the source is associated with the caller.

30. The system according to claim 29, wherein the source includes one or more contacts folders maintained by the information assistance service provider.

31. The system according to claim 24, wherein the message identifier is associated with a communications device from which the call originates.

32. The system according to claim 31, wherein the communications device includes a telephonic device, and the message identifier includes a telephone number.

33. The system according to claim 24, wherein the first data and second data are transmitted pursuant to a VoIP.

34. The system according to claim 24, wherein the network comprises a telephone network.

35. The system according to claim 24, wherein the network comprises at least part of the Internet.

36. The system according to claim 24, wherein the call is reconnected to the information assistance service provider after the call, which was originally destined to a device associated with a recipient of the message, is not completed.

37. The system according to claim 24, wherein a reply from a recipient of the message is facilitated.

38. The system according to claim 37, wherein the caller specifies the preferred reply method.

39. A system for sending a message using an information assistance service provider, comprising:
an interface for receiving data including a first message identifier from the information assistance service provider;
a processor for recording message content associated with a second message identifier; and
a device for transmitting the message to a destination indicated in the data, the message including the message content when the first message identifier corresponds to the second message identifier,
wherein the information assistance service provider receives a call from a caller, obtains the data, and provides a connection between the caller and the system.

40. The system according to claim 39, wherein the message content includes at least one of audio, video, and text data.

41. The system according to claim 39, wherein the data includes a destination address.

42. The system according to claim 41, wherein the message includes an e-mail, and the destination address includes an e-mail address.

43. The system according to claim 39, wherein at least part of the data is obtained from the caller during the call.

44. The system according to claim 41, wherein at least part of the data is obtained by searching a source accessible by the information assistance service provider.

45. The system according to claim 44, wherein the source is associated with the caller.

46. The system according to claim 45, wherein the source includes one or more contacts folders maintained by the information assistance service provider.

47. A method for replying to a message sent using an information assistance service provider, comprising:
receiving by the information assistance service provider a request from a message recipient to send a reply to a message sender, the request including message-identifying data and the reply including at least first and second portions thereof;
in response to the request, obtaining first data concerning the first portion of the reply;
providing the first data and a reply identifier to a message server for sending the reply; and
connecting to the message server through a network to allow the recipient to communicate to the message server second data concerning the second portion of the reply,
whereby the message server realizes the reply by associating first data and second data based on the reply identifier.

48. The method according to claim 47, wherein the request is made via a telephone call.

49. The method according to claim 47, wherein the request is made via a communication network.

50. The method according to claim 47, wherein the message-identifying data is used to obtain at least part of the first data.

51. The method according to claim 47, wherein the first data includes a destination address of the reply.

52. The method according to claim 47, wherein the reply includes an e-mail, and the destination address includes an e-mail address.

53. The method according to claim 47, wherein the second data includes at least one of audio, video, and text data.

54. The method according to claim 47, wherein at least part of the first data is obtained using the message-identifying data.

55. The method according to claim 47, wherein at least part of the first data is obtained by searching a source accessible by the information assistance service provider.

56. The method according to claim 55, wherein the source is associated with the recipient.

57. The method according to claim 55, wherein the source is associated with the message sender.

58. The method according to claim 47, wherein the reply identifier is associated with a communications device from which the request originates.

59. The method according to claim 58, wherein the communications device includes a telephonic device, and the reply identifier includes a telephone number.

60. The method according to claim 47, wherein the first data and second data are transmitted pursuant to a VoIP.

61. The method according to claim 47, wherein the network comprises a telephone network.

62. The method according to claim 47, wherein the network comprises at least part of the Internet.

63. The method according to claim 47, wherein the caller specifies the preferred reply method.

64. A system for replying to a message sent using an information assistance service provider, comprising:
an interface for receiving by the information assistance service provider a request from a message recipient to send a reply to a message sender, the request including message-identifying data and the reply including at least first and second portions thereof;
a first mechanism responsive to the request for obtaining first data concerning the first portion of the reply;
a device for providing the first data and a reply identifier to a message server for sending the reply; and
a second mechanism for connecting to the message server through a network to allow the recipient to communicate to the message server second data concerning the second portion of the reply, the reply identifier being provided to the message server in connecting the call to the message server,
whereby the message server realizes the reply by associating first data and second data based on the reply identifier.

65. The system according to claim 64, wherein the request is made via a telephone call.

66. The system according to claim 64, wherein the request is made via a communication network.

67. The system according to claim 64, wherein the message-identifying data is used to obtain at least part of the first data.

68. The system according to claim 64, wherein the first data includes a destination address of the reply.

69. The system according to claim 64, wherein the reply includes an e-mail, and the destination address includes an e-mail address.

70. The system according to claim 64, wherein the second data includes at least one of audio, video, and text data.

71. The system according to claim 64, wherein at least part of the first data is obtained using the message-identifying data.

72. The system according to claim 64, wherein at least part of the first data is obtained by searching a source accessible by the information assistance service provider.

73. The system according to claim 72, wherein the source is associated with the recipient.

74. The system according to claim 72, wherein the source is associated with the message sender.

75. The system according to claim 64, wherein the reply identifier is associated with a communications device from which the request originates.

76. The system according to claim 75, wherein the communications device includes a telephonic device, and the reply identifier includes a telephone number.

77. The system according to claim 64, wherein the first data and second data are transmitted pursuant to a VoIP.

78. The system according to claim 64, wherein the network comprises a telephone network.

79. The system according to claim 64, wherein the network comprises at least part of the Internet.

80. The system according to claim 64, wherein the caller specifies the preferred reply method.

81. A method for entering data into data fields of a message, the message being sent using an information assistance service provider, the method comprising:
receiving by the information assistance service provider a call from a caller, the call including a request for sending a message, the message including at least first and second portions thereof, the first portion containing the data fields;
in response to the request, obtaining a caller identifier;
obtaining data based upon the caller identifier; and
automatically entering the data into the data fields.

82. The method according to claim 81, wherein the caller identifier is associated with a communications device from which the call originates.

83. The method according to claim 82, wherein the communications device includes a telephonic device, and the caller identifier includes a telephone number.

84. The method according to claim 83, wherein the caller identifier is determined using automatic number identification (ANI).

85. The method according to claim 83, wherein the caller identifier is determined using a mobile identification number (MIN).

86. The method according to claim 81, wherein the caller identifier includes a voiceprint.

87. The method according to claim 81, wherein the caller identifier includes the caller's name.

88. The method according to claim 81, wherein the caller identifier includes a code provided by the caller.

89. The method according to claim 81, wherein at least part of the data is obtained by searching a source accessible by the information assistance service provider.

90. The method according to claim 89, wherein the source is associated with the caller.

91. The method according to claim 90, wherein the source includes one or more contacts folders maintained by the information assistance service provider.

92. The method according to claim 90, wherein the source includes a profile containing the caller's preferences.

93. The method according to claim 92, wherein the profile includes a history of data previously entered into the data fields.

94. The method according to claim 81, wherein the data automatically entered into the data fields comprises data previously entered into those fields.

95. The method according to claim 94, wherein the previous data is the data most recently used in that data field.

96. The method according to claim 94, wherein the previous data is the data most frequently used in that data field.

97. The method according to claim 81, wherein automatically entering data into the data field comprises automatically completing an entry based on entries from a lookup table.

98. The method according to claim 81, wherein the call is reconnected to the information assistance service provider after the call, which was originally destined to a device associated with a recipient of the message, is not completed.

99. The method according to claim 81, further comprising:
providing the data and a message identifier to a message server for sending the message;
connecting the call to the message server through a network to allow the caller to communicate to the message server second data concerning the second portion of the message; and
providing the message identifier to the message server in connecting the call to the message server,
whereby the message server realizes the message by associating the data and the second data based on the message identifier.

100. The method according to claim 99, further comprising facilitating a recipient of the message to reply to the message.

101. The method according to claim 81, further comprising facilitating a recipient of the message to reply to the message.

102. A system for entering data into data fields of a message, the message being sent using an information assistance service provider, the system comprising:
an interface for receiving by the information assistance service provider a call from a caller, the call including a request for sending a message, the message including at least first and second portions thereof, the first portion containing the data fields;
a first mechanism responsive to the request for obtaining a caller identifier and for obtaining data based upon the caller identifier; and
a second mechanism for automatically entering the data into the data fields.

103. The system according to claim 102, wherein the caller identifier is associated with a communications device from which the call originates.

104. The system according to claim 103, wherein the communications device includes a telephonic device, and the caller identifier includes a telephone number.

105. The system according to claim 104, wherein the caller identifier is determined using automatic number identification (ANI).

106. The system according to claim 104, wherein the caller identifier is determined using a mobile identification number (MIN).

107. The system according to claim 102, wherein the caller identifier includes a voiceprint.

108. The system according to claim 102, wherein the caller identifier includes the caller's name.

109. The system according to claim 102, wherein the caller identifier includes a code provided by the caller.

110. The system according to claim 102, wherein at least part of the data is obtained by searching a source accessible by the information assistance service provider.

111. The system according to claim 110, wherein the source is associated with the caller.

112. The system according to claim 111, wherein the source includes one or more contacts folders maintained by the information assistance service provider.

113. The system according to claim 111, wherein the source includes a profile containing the caller's preferences.

114. The system according to claim 113, wherein the profile includes a history of data previously entered into the data fields.

115. The system according to claim 102, wherein the data automatically entered into the data fields comprises data previously entered into those fields.

116. The system according to claim 115, wherein the previous data is the data most recently used in that data field.

117. The system according to claim 115, wherein the previous data is the data most frequently used in that data field.

118. The system according to claim 102, wherein the data is automatically entered into the data field by automatically completing an entry based on entries from a lookup table.

119. The system according to claim 102, wherein the call is reconnected to the information assistance service provider after the call, which was originally destined to a device associated with a recipient of the message, is not completed.

120. The system according to claim 102, further comprising:
a device for providing the data and a message identifier to a message server for sending the message; and
a third mechanism for connecting the call to the message server through a network to allow the caller to communicate to the message server second data concerning the second portion of the message, the message identifier being provided to the message server in connecting the call to the message server,
whereby the message server realizes the message by associating the data and the second data based on the message identifier.

121. The system according to claim 120, wherein a reply from a recipient of the message is facilitated.

122. The system according to claim 102, wherein a reply from a recipient of the message is facilitated.

123. A method for sending a message using an information assistance service provider, comprising:
receiving by the information assistance service provider a call from a caller;
attempting to establish a connection over a channel to a destination telephone;
detecting that the connection status on the channel is incomplete;
returning the caller to the information assistance service provider;
prompting the caller to request to send a message, the message including at least first and second portions thereof;
in response to the request, obtaining first data concerning the first portion of the message;
providing the first data and a message identifier to a message server for sending the message;
connecting to the message server through a network to allow the caller to communicate to the message server second data concerning the second portion of the message; and
providing the message identifier to the message server in connecting to the message server,
whereby the message server realizes the message by associating first data and second data based on the message identifier.

124. The method according to claim 123, wherein the connection status is incomplete due to a busy signal, a ring-no-answer condition, or a network communication problem.

125. A system for sending a message using an information assistance service provider, comprising:
an interface for receiving by the information assistance service provider a call from a caller;
a switch for attempting to establish a connection over a channel to a destination telephone;
a processor for detecting that the connection status on the channel is incomplete and for returning the caller to the information assistance service provider;
a voice response unit for prompting the caller to request to send a message, the message including at least first and second portions thereof;
a first mechanism responsive to the request for obtaining first data concerning the first portion of the message;
a device for providing the first data and a message identifier to a message server for sending the message; and
a second mechanism for connecting to the message server through a network to allow the caller to communicate to the message server second data concerning the second portion of the message, the message identifier being provided to the message server in connecting to the message server,
whereby the message server realizes the message by associating first data and second data based on the message identifier.

126. The system according to claim 125, wherein the connection status is incomplete due to a busy signal, a ring-no-answer condition, or a network communication problem.
